(19) United States
(12) Patent Application Publication
(10) Pub. No.: US 2017/0144932 A1
(43) Pub. Date: May 25, 2017

(54) Method for the Production of Cold-Process Bituminous Coatings

(71) Applicant: S. A. Lhoist Recherche et Developpement

(72) Inventor: Didier LESUEUR, Braine-le-Chateau (BE)

(21) Appl. No.: 15/322,498

(22) PCT Filed: Jul. 10, 2015
(86) PCT No.: PCT/EP2015/065880

§ 371 Date: Dec. 28, 2016

(30) Foreign Application Priority Data
Jul. 10, 2014 (BE) 20140528
Jul. 10, 2014 (FR) 1456678

(51) Int. Cl. C04B 26/26; E01C 7/20; E01C 7/35; C04B 22/06

(52) U.S. Cl. CPC C04B 26/26; C04B 22/064; E01C 7/20; E01C 7/353; C04B 2103/0005

(57) ABSTRACT

A method is shown for preparing cold-process bituminous coatings, in particular the preparation of wear surface dressings which method includes the steps of preparing a bituminous binder as a cationic emulsion of bitumen; preparing an aggregate comprising at least one first aggregate fraction; and forming said cold-process bituminous coating formed with at least said aggregate interpenetrated into said binder; characterized in that said step for preparing said aggregate comprises a step for coating said at least one first aggregate fraction with lime.

The present invention relates to a method for improving the adhesiveness (at the interface) of the binder to the aggregate, the consistency (in the bulk) and the setting speed (consistency over time) of cold-process bituminous coatings, in particular wear surface dressings (WSD). More particularly, the present invention relates to a method for preparing cold-process bituminous coatings, in particular wear surface dressings (WSD), comprising the steps of:
a) preparing a bituminous binder as a cationic emulsion of bitumen,
b) preparing a aggregate comprising at least one first fraction of a aggregate, and
c) forming said cold-process bituminous coating, formed with at least said aggregate interpenetrated into said binder.

Such methods for preparing cold-process bituminous coatings are well known.

Generally, bituminous coatings are obtained from a mixture of aggregates and of a bituminous binder. More specifically, cold-process bituminous coatings are distinguished from hot- or warm-process bituminous coatings depending on how this bituminous binder is supplied.

Thus, in the case of hot-process bituminous coatings, the bitumen being too viscous at room temperature, it has to be softened by heating to temperatures of the order of 160° C. so as to be able to be handled. Also, the aggregates have to be dried for allowing a good coating with the hot bitumen. The coating is accordingly manufactured at a temperature of the order of 160° C.

In order to avoid or at least reduce the energy consumption and the associated emissions (fumes, greenhouse gases, . . . ,) other techniques have been developed. As such, warm bituminous coatings (also sometimes called semi-warm bituminous coatings) allow, by the use of additives or by a clever modification of the hot industrial process, reduction in the manufacturing temperatures from 10 to 60° C. However, the drying step for the aggregates is always necessary and the industrial process then remains very close to that of the cold-process bituminous coating. Aso, the bitumen remains handled at temperatures of the order of a 160° C. As such, the warm asphalt mixes are presented by the roadway industry as being comparable in any point to cold-process bitumen mixes, except for their application temperature.

In the case of cold-process bituminous coatings, the systematic drying of the aggregate is no longer required and these techniques therefore use methods which are completely different from those used for the hot or warm process. Indeed, the bitumen is then made able to be handled at room temperature mainly by putting it into an emulsion, but also via the use of fluxed bitumen or bitumen foam. As a consequence of this way of supplying the binder, the cold-process bituminous coatings are subject to a selling phenomenon, which is shown by the fact that their final properties are not obtained instantaneously and that one passes from an initial sufficiently <<fluid>> condition allowing the application, to a final cohesive condition which resists to the traffic, according to kinetics ranging from a few tens of minutes to several years. The formulator therefore has to control the cohesion (overall aptitude of resisting the forces related to the traffic), the adhesion (capability of maintaining a permanent link between binder and aggregate) and the setting speed (kinetics of the passage from the initial state to the final state).

Bitumen emulsions are emulsions comprising emulsified bitumen in an aqueous phase. In practice, bitumen emulsions are especially cationic emulsions, i.e. obtained by means of positively charged emulsifiers. The most current cationic emulsifiers are organic compounds from the class of amines, either a slurry or liquid at room temperature. As these emulsifiers are generally insoluble in water, a sufficient amount of a mineral or organic acid is added in order to ionize the amine functions of the emulsifiers in order to allow their dissolution in water. In certain cases, it may also be advantageous to use together another emulsifier, for example an amphoteric surfactant.

Anionic bitumen emulsions are also known. However, the anionic emulsifiers only play the additional role of an adhesiveness dopant described later on, for limestone aggregates, which are generally excluded from the layers of road surfaces because of their low resistance to polishing.

Fluxed bitumen is a mixture of bitumen and of a fluxing agent of a petroleum, coal or plant origin, giving the possibility of reducing the viscosity thereof. However, its use generally implies emissions of volatile organic compounds (VOC) which one seeks to reduce by preferring the emulsion techniques.

Bitumen foam is a means for making the bitumen able to be handled at room temperature, by addition of small amounts of water (a few %) to the hot bitumen, thereby causing its foaming. This technique was used successfully for producing WSDs but suffers from the need of dedicated machines and of highly specific formulations which has caused quasi-disappearance of its use in WSD. However it remains used for the re-treatment in the place of roadways, in particular in the presence of significant amounts of granular materials non-bound or treated with hydraulic binders.

All these roadway techniques combining the use of bitumen which may be handled at room temperature and of an aggregate are known together as “cold techniques”. Cold techniques advantageously give the possibility of doing without the energy-consuming step of drying of the aggregate, required in the cold or warm techniques for ensuring good adhesive bonding of the binder to the aggregate in the presence of an anhydrous binder. For example, in the cold-process bituminous coatings based on a bitumen emulsion, this adhesive bonding is ensured in spite of the presence of water, since the emulsifier is selected so as to be also able to play the role of a dopant for adhesiveness (see further on).

In cold-process bituminous coatings, the bituminous binder is therefore typically prepared as a bituminous emulsion or a fluxed bitumen and is applied on the surface to be covered, for example the surface of a roadway. The bituminous binder may be applied on a aggregate layer already laid on the surface or before laying the aggregate layer. Alternatively, the bituminous binder and the aggregate may first be mixed together and then distributed over the surface to be coated. In every case, the two materials (the aggregate and the binder) interpenetrate each other and set together.

By cold-process bituminous coating, is meant in the sense of the present invention, the wear surface dressings (WSD) and the cold bitumens, wherein the emulsion is kneaded with the aggregate which may exclusively or partly consist of aggregates of bitumens (in the sense of the EN 13108-8 standard), which include cold dense bitumens, grave emulsions or further re-treatment of the emulsion (see the document <<Les Emulsions de Bitume>> (Bitumen emulsions) mentioned below).

The technique of WSDs consist of supplying the binder with one or several layers, followed and/or preceded with the supply of one or several layers of aggregates. In this case, the binder is generally provided as a bitumen emulsion.

The cold dense bitumens and the grave emulsions are bitumens obtained by mixing in a coating plant, aggregates of a bitumen emulsion. The cold dense bitumens are characterized by a stronger binder content than the grave emulsions, which allows better strength towards water and a better resistance to detachment, allowing use in a pavement layer under strong traffic. The grave emulsions, because of their lower content of binder, are much more able to be handled and thus allow preferential use in a re-profiling or reloading layer, in particular for constraints of variable thicknesses related to a heterogeneous support, where they may be directly subject to low traffic, or be covered for example with an WSD or with a cold dense bitumen under stronger traffics. They may also be used as a base layer in a new roadway.

The re-treatment as a bitumen emulsion or foam corresponds to the production of a grave emulsion or a grave foam in a plant or in situ by means of dedicated machines. The milled material of ancient roadways is then mixed with a binder added as a bitumen emulsion or a bitumen foam. The properties are close to those of grave emulsions, with the economical and environmental advantage of using as a raw material the milled materials which otherwise would be a construction waste and will thereby limit the use of new aggregates.

There also exists another type of cold-process bituminous coating, called a cold-cast bitumen (CCB). The CCB is a form of a thin coating which has a field of use dose to that of WSDs. On the other hand, it differs therefrom by the formulation, which is systematically based on a bitumen emulsion and by the application methods, which use dedicated machines which carry away the whole of the ingredients (humid aggregate, water, bitumen emulsion, lime milk and other additives) and distributes them in a single operation with a great yield. The main difference between CCBs and the other cold-process coatings, is that they form a class of materials for which the formulation has been optimized these recent years so as to control the breakage thereof, by the use of switches/retarder pairs which give the possibility of finely controlling the breakage of the emulsion. On the other hand, these technologies have not been diffused in the field of WSDs or cold bitumens (dense, grave emulsions or re-treatments in situ), wherein the application technologies made it difficult to multiply the additives. Also, CCBs are made in situ within a very short time (of the order of one to two minutes) between the mixing of the ingredients and their laying, thereby giving the possibility of allowing for quick delivery to the traffic, provided that the emulsion breaks rapidly. On the other hand, the grave emulsions and the cold bitumens are transported by truck from the plant to the site, requiring a delay in handling capability of several hours.

The standard EN 12271 describes the surface wear coatings (SWC), while the standard EN 12273 is dedicated to cold cast bitumens (CCB).

The document edited by the Section of the Manufacturers of Roadway Bitumen Emulsions (SMRBE) from the <<I'Union des Syndicats de I'Industrie Routière Frangaise>> (USIRF), entitled <<Bitumen Emulsions>> (Paris: Revue Générale des Routes et Aérodromes Ed., 2006) particularly describes the techniques and methods using bitumen emulsions as a binder such as WSDs, CCBs and the whole of the cold techniques.

The problem of roadway techniques with a bitumen emulsion is that the water is only used as a carrier for providing the bitumen and therefore should then disappear while only leaving the binder. The whole of the physico-chemical processes allowing the transition of the emulsion to the final bitumen film is generally called in the business <<breakage of the emulsion>>. Breakage is therefore meant as the transition for the binder, from an initial state where it is dispersed in an aqueous phase (emulsion) to a final state where it forms a continuous, more or less rigid film, often called <<residual binder>>. This phenomenon occurs naturally, by gradual evaporation of the water. However, notably depending on the applications, on the building site constraints and on the climate (temperature, humidity of the air, wind, . . . ), the breakage of the emulsion may be accelerated by means of one or several additives commonly called emulsion breakers.

Under these conditions, the use of lime for causing the breakage of the emulsion is a known solution but not very used because of the violence of the reaction. The use of lime as a breaker comes from the fact that it neutralizes the acid and therefore brings the surfactant into a pH domain wherein it loses its charge and therefore its surfactant nature. As lime forms a strong base, this reaction is difficult to control and generates a breakage often described as a violent breakage.

Because of the violence of the breakage, its application on an industrial scale is limited to rare cases of roadway techniques with a bitumen emulsion wherein the formulator has known how to adjust this breakage violence with the operational specificities specific to the targeted application, notably (i) by means of lime milk provided in a stabilized form or made in a form concentrated in situ (supply of hydrated lime to a formulation moreover already containing water) in the CCBs, wherein all the ingredients are mixed together during a single operation (humid aggregate, water, bitumen emulsion, lime milk and other optional additives such as setting retarders), or (ii) by means of the lime milk made in situ in the re-treatment in the place of the bitumen emulsion wherein the ingredients are also kneaded together in a single step (milled material of old bitumen, water, bitumen emulsion, hydrated lime). This is exclusively possible since these technologies are carried out in situ with special machines, giving the possibility of limiting the time between the contacting of the ingredients and the laying, which allows the use of violent breakers.

The main application of the bitumen emulsions in terms of bituminous coating, is the technique of WSD. This technique is economical and is well suited for routes with moderate traffic which form the essential part of the local road network (notably the departmental network in France).

Unfortunately, the use of lime milk as a breaker directly added to the emulsion does not operate in WSDs since the breakage is too violent therein and promotes the formation of a skin broken at the surface, confining the water below.

The wear surface dressings (WSDs) also suffer from a major disadvantage: they poorly resist the forces related to the traffic when they are young, i.e. very little time after their application. The result of this is a risk of projection of aggregates which may cause breakages of windshields. For this purpose, the formulator tries to accelerate the setting speed thereof and/or improve the adhesion of the binder to the aggregate and/or the cohesion of the binder. This disadvantage has been the subject of research and development which have resulted in certain solutions as described in the document (<<Code de bonne pratique des enduits superficiels>>, CRR Ed.: Brussels, 2001—Recommendations R 71101, http://www.brrc.be/publications/r/r7101. pdf—“Roadway Research Centre (RRC)”.

According to this document, the solutions giving the possibility of improving the adhesiveness of the binder to the aggregate in the WSDs are summarized as follows:

1) the aggregate should be as clean as possible (without any fines notably) and dry,

2) if in spite of the use of a clean aggregate, the adhesiveness is insufficient, the use of a dopant is a usual solution. The dopant is typically an organic surfactant compound and often an amine surfactant, which is thus close to the cationic emulsifiers for bitumen. The dopant may be put into the binder (in the case of bitumen emulsions, the emulsifier is selected so as to also play the role of dopant), on the aooregate (pre-coating of the aggregate with the surfactant) or at the interface between the binder and the aggregate.

In this second case, one of the drawbacks, in particular relating to the treatment of the aggregate, is the control of low contents of organic additives (usual dosage from 0.1 to 0.5% by mass of diluted solutions of a surfactant relatively to the aggregate). Also, these surfactants are generally amine derivatives obtained by complex and polluting organic synthesis methods, with unfavorable eco-toxicological profiles (in particular, many are classified as hazardous for the environment).

It should be noted that hydrated lime is known for having a role similar to that of the adhesiveness dopants, when it is added to the hot- or warm process bitumens. Thus, the formulator which uses an emulsifier also playing the role of a dopant is not tempted to also add lime, since this would be a double use and would therefore form an unnecessary co it.

For the coatings (WSDs) with fluxed bitumen, the pre-coating with bitumen of the aggregates is a usual solution for improving the adhesiveness. On the other hand, it represents a consequent economical and operational overcost, since the aggregates have to pass through an industrial facility (coating plant) where they are dried and then coated with typically 1% by mass of bitumen. The environmental benefit of cold techniques is then lost, since the energy-consuming drying of the aggregates is then reintroduced.

In the case of cold bitumens, it is known how to use sequential coating and/or double coating with the emulsion and/or the use of emulsions of different grades of bitumen techniques in order to obtain a distribution as homogenous as possible of the binder on the whole of the fractions. These methods also aim at increasing the adhesiveness, the cohesion and the setting speed of the cold bitumens but represent an increased industrial complexity requiring major modifications in the facilities and accordingly a notorious economical overcost.

The object of the invention is to overcome the drawbacks of the state of the art by providing a method which gives the possibility of increasing the adhesiveness of the binder to the aggregate and the cohesion of the cold-process bituminous coating when it is young, without representing an economical overcost and without having significant toxicological hazards.

For this purpose, according to the invention, a method is provided as indicated at the beginning, characterized in that said step for preparing said aggregate comprises a step for coating said at least one first aggregate fraction with lime, for example from a lime composition.

Indeed it was observed according to the present invention that the preliminary coating (treatment) of at least one first fraction of the roadway aggregate with lime for forming a cold-process bituminous coating, gave the possibility of increasing the adhesiveness of the binder to the aggregate and the cohesion and the setting speed of the bituminous coating, in particular when it is young (setting phenomenon), without representing an economical overcost and without having significant toxicological hazards.

This further allows the collateral advantage of thus extending the application of these coatings, which are otherwise limited to favorable weather conditions, difficult to obtain in Europe out of the period from April to September (temperature of the support ideally greater than 10° C. and low humidity). This also gives the possibility of limiting departures of young aggregate, which limit the trafficability of the coatings just after their laying and which may generate windshield breakages.

By the term of lime is meant in the sense of the present invention, calcium hydrated limes, dolomitic hydrated limes, hydrated magnesias, calco-magnesium hydrated limes, quick calcium limes, magnesia, calco-magnesium or dolomitic quick limes, quick limes with retarded reactivity, such as for example partially pre-hydrated limes, over-baked quick limes, partly slaked limes with exogenous additives and mixtures thereof, filter dusts, flying ashes, in particular calcium ashes, Portland cements, hydraulic limes, building limes as defined in the EN 459-1 standard, and mixtures thereof.

The use of lime, in particular of hydrated lime is already known in the hot-process bituminous coatings, wherein lime improves the adhesiveness of the bitumen to the aggregate, slows down the ageing of the bitumen and improves the mechanical properties, all of this increasing the lifetime of the bitumen. In this case, lime milk is added to the aggregate before its drying and then its coating with bitumen (see for example D. Lesueur, <<Increasing the durability of asphalt mixtures with hydrated lime: A critical review of the literature>>, Report to the European Lime Association, Version 2, April 2010; National Lime Association, “How to Add Hydrated Lime to Asphalt—An Overview of Current methods”, National Lime Association Report, 2003—http://www.lim.org/documents/publicatiosn/free downloads/how-to-add-lime.pdf). This application is however distinct from those contemplated here, since hot bitumens are different materials manufactured according to specific methods and meeting different standards (series EN 13108-1 to 7 in Europe).

The techniques using hot bitumens are described in GB 2,327,669 and in <<Development and analysis of cement coated aggregates for asphalt mixture>> of Bayoni Fouad (XP002108078).

The use of hydrated lime in warm bitumens is also already known. Document WO 12/009339 describes the use of lime milk for producing a warm bitumen. Warm bitumens are methods close to hot bitumens, from which it is sought to obtain the same final properties by lowering the manufacturing temperature by different methods (additives, methods or a combination of both). There is no possible confusion between the coatings targeted by the present invention and the use of lime milk as a treatment for aggregates for warm and hot bitumens, since the industrial methods are different and the final products come under different properties and standards. Indeed, the main problem to be solved for cold-process coatings is the control of the breakage of the emulsion so as to ensure good initial cohesion and a small detachment of aggregates in order to put it back under rapid traffic, and no solution coming from hot or warm bitumens is therefore transposable since the bitumen is not in the form of an emulsion.

Further, up till now, the use of lime has never been generalized in cold-process bituminous coatings.

Indeed, cold-process bituminous coatings are mainly obtained from a bitumen emulsion or fluxed bitumen. Hydrated lime is known to be an emulsion breaker sometimes too violent, promoting as such a breaking of skin in the WSD, and thus making its application very limited. The only field where it is used today notoriously comprises CCBs and re-treatments on site, for which an adapted formulation has then to be obtained but by a highly specific expertise mastered by a limited number of actors, and corresponding to requirements which are not transposable to the other cold-process coatings obtained by coating, subsequent to the short period between the mixing of the constituents and their aying. This limitation moreover was until today a major technical prejudice which widely separated one skilled in the art from the solution provided by the present invention.

For example, document U.S. Pat. No. 3,206,174 deals with the formation of CCBs and teaches the addition, in the mixture containing the aggregates and the bitumen emulsion, of a small amount of fine particles such as cement or lime particles.

Document U.S. Pat. No. 4,193,816 teaches the addition of slaked lime to the aggregates before mixing them with an anionic bitumen emulsion in order to form CCBs In addition to being limited to CCBs, this document uses anionic bitumen emulsions, consequently resorting to a failure mechanism completely different from the one encountered with cationic emulsions. Indeed, as mentioned earlier, lime allows the breakage of cationic emulsions by a pH effect. On the contrary, in this document, the lime is used because of its capability of releasing Ca²⁺ ions which may then form insoluble complexes with the anionic emulsifiers. This mechanism is therefore exclusive of these emulsifiers, the use of which in a roadway technique has become anecdotal because of their low adhesiveness.

Document GB 581,187, as for it, describes a pre-coating of aggregates with lime for forming cold process bituminous coatings based on tar or fluxed bitumen, and explains that this solution does not work with bitumen emulsions.

Therefore it is particularly surprising that the present invention gives the possibility of obtaining an improved adhesiveness of the binder to the aggregate and of increasing the cohesion and the setting speed of many cold-process bituminous coatings by using roadway techniques with a bitumen emulsion, in particular WSDs, by coating the aggregate or a fraction thereof with lime. Indeed, the recommendations particularly for WSDs, recommend first trying to obtain a clean aggregate and without any fines in order to improve the adhesiveness of the binder. A preliminary aggregate coated with lime is therefore a solution which goes against the existing present teachings. This, combined with the other technical prejudice lying in the fact that lime is a violent emulsion breaker, makes the present invention appear particularly surprising and inventive.

Further, the solution of pre-coating the aggregate or a fraction thereof with lime takes place, in its application and in its principle, like a pre-treatment by means of a surfactant, which gives the possibility of using without any major modifications, facilities presently used required for the existing methods, and unlike the pre-coating techniques with bitumen. Further, coating with lime is an inexpensive mineral solution, without any toxicological and environmental hazards, easy to control in terms of verification of the dosages relatively to the organic additives,

The probable action mechanisms are double. First of all, the amount of lime supplied through this route consisting in a surface treatment, may be more easily controlled than for a bulk mixture of all the constituents. In this way, the violent breakage effect is limited to a small amount of emulsion. Next, this breakage is preferentially accomplished at the surface of the aggregate where the lime is found, thereby promoting anchoring of bitumen droplets forming the emulsion. This point therefore contributes to improving adhesiveness, which in return ensures a more homogenous distribution of the binder within the coating, which then also contributes to improving the cohesion.

In an advantageous embodiment of the present invention particularly targeted on CCBs, the method comprises:

i) at least one supply of said bituminous binder on a surface to be coated, in order to form at least one binder layer on said surface to be coated,

ii) at least one supply of said aggregate on said surface to be coated, before or after said bituminous binder, and wherein said bituminous coating is formed with at least one layer of said aggregate interpenetrated into said bituminous binder.

in a preferred embodiment of the method according to present invention, said bituminous coating formed with at least one layer of said aggregate interpenetrated into said bituminous binder comprises an asymmetrical or symmetrical number of bituminous binder layers and of aggregates optionally in alternation.

In an alternative according to present invention, particularly targeted on cold-process bitumens, which include grave emulsions, the cold-process dense bitumens and the emulsion re-treatments,

i) said bituminous binder is brought into a kneader,

ii) said aggregate is brought into said kneader, during, before or after said bituminous binder, and

iii) said bituminous binder is formed with the mixture of said aggregate interpenetrated into said binder and is applied on a surface to be coated.

The mixture of the coated aggregate and of the binder may therefore, in an alternative to the preparation of the bituminous coating in situ, be prepared in a coating plant, optionally mobile or installed on a self-driven platform, before its application on the roadway.

Advantageously, in the method according to present invention, said step for coating said at least one first fraction of aggregate comprises an application of a lime composition on said at least one first fraction of aggregate by immersion, soaking, vaporization, spraying or mixing in an amount of a lime content from 0.05 to 2% by weight expressed in hydroxide equivalent (Ca(OH)₂ and/or Mg(OH)₂) based on the total weight of aggregate.

Indeed according to present invention it was observed that the particular range of lime content, comprised between 0.05 and 2% gave the possibility of improving the cohesion and the setting speed, as well as the adhesiveness of the binder to the aggregate. As this may be seen, this range of values represents a relatively low consumption of the additive, but sufficient for simplifying the dosages thereof. As too restricted values are often difficult to dose and the distribution on the aggregates consequently becomes doubtful. On the contrary, too high values lead to a too rapid breakage of the emulsion.

The treatment of the aggregate or of the aggregate fraction may be achieved by any suitable means allowing good control of the lime content and may be adapted depending on the powdery or liquid nature of the lime used. In a non-restrictive way, the aggregate may be mixed with the lime in a kneader, for example similar to those found in concrete plants. The lime may also be directly sprayed at the surface of the aooregate with a spraying system on a conveyor belt or at the outlet of a chip spreader truck then using devices similar to the dopant ramps already marketed. The treatment may be achieved just before putting the aggregate in contact with the emulsion or further upstream in the quarry, with storage which may last up to a few days. Longer storage is not recommended since it would induce carbonation of the lime which would then be transformed into calcium carbonate and would consequently lose its activity.

In a particular embodiment, said lime is selected from the group formed with calcium hydrated limes, dolomitic hydrated limes, hydrated magnesias, calco-magnesium hydrated limes, quick calcium limes, magnesia, calco-magnesium or dolomitic quick limes, quick limes with retarded reactivity, such as for example partly pre-hydrated limes, over-baked quick limes, partly slaked limes with exogenous additives and mixtures thereof, filter dusts, flying ashes, in particular with calcium, Portland cements, hydraulic limes, construction limes as defined in the EN 459-1 standard, and mixtures thereof.

According to the present invention, the lime will therefore for example be selected according to the aggregate and in particular according to its water content.

Indeed, according to the invention, provision is made for treating a too humid aggregate with quick lime in order to reduce the water content and obtain a lime milk in situ, or to provide the lime as a dry hydrated lime, on a slightly humid aggregate for which the intention is not to modify the water content, or else provide the lime as lime milk. In this way, a tailored solution may be contemplated depending on the initial water content of the aggregate and on its desired final water content.

An excess of quick lime may also be used in order to have a reserve of exothermicity upon contact with the water provided by the emulsion and/or the aggregate and/or the cold process.

The calcium hydrated lime consists of a set of solid particles, mainly calcium di-hydroxide of formula Ca(OH)₂, and is the industrial result of the slaking of quick lime with water, a reaction also called a hydration. This product is also known under the name of slaked lime. Subsequently, the calcium di-hydroxide will be simply designated as calcium hydroxide.

This slaked lime may also contain calcium oxide which would not have been hydrated during the slaking, just like it may contain calcium carbonate CaCO₃. This calcium carbonate may either stem from the initial limestone from which the slaked lime is derived according to the invention (non-baked), or from a partial carbonation reaction of slaked lime in contact with air. The calcium oxide content in the slaked lime within the scope of the present invention is generally less than 3% by mass, preferably less than 2% and advantageously less than 1%. That of calcium carbonate is less than 10% by mass, preferably less than 6% and advantageously less than 4%, still more advantageously less than 3%.

This slaked lime may also contain magnesium oxide MgO or derived phases of the Mg(OH)₂ or MgCO₃ type, globally representing a few tens of grams per kilogram. Nevertheless, the sum of these impurities, expressed as MgO, does not advantageously exceed 5% by mass, preferably 3%, preferably 2% or even 1% of the weight of calcium hydrated lime according to the invention.

Dolomitic hydrated lime consists of a set of solid particles, mainly calcium di-hydroxide of formula Ca(OH)₂, magnesium di-hydroxide Mg(OH)₂ and magnesium oxide, and fitting the general formula aCa(OH)₂.bMg(OH)₂.cMgO. a, b and c represent the mass fractions for which the sum has the value from 60 to 100%. The particles further contain 0 to 40% by mass fraction of diverse compounds D, which may obviously contain impurities, i.e. derived phases from SiO₂, Al₂O₃, Fe₂O₃, MnO, P₂O₅ and/or SO₃, globally representing a few tens of grams per kilogram of lime. These solid particles may also contain as a compound D, calcium oxide which would not have been hydrated during the slaking, just like they may contain calcium carbonates CaCO₃ and/or magnesium carbonate MgCO₃, optionally combined as dolomite.

This dolomitic hydrated lime is the industrial result of the slaking of a quick dolomite with water, a reaction also called hydration. This product is also known as slaked dolomitic lime. Subsequently, the calcium and magnesium di-hydroxide will be designated simply as calcium or magnesium hydroxide. The proportion of calcium and magnesium is typically dictated by the native proportion existing in the different ores and is typically comprised between 0.8 and 1.2.

The hydrated magnesias consist of a set of solid particles, mainly magnesium di-hydroxide of formula Mg(OH)₂, and are the industrial result of slaking of quick magnesia with water, a reaction also called a hydration.

The calcium-magnesium hydrated lime consists of a set of solid particles, mainly calcium di-hydroxide of formula Ca(OH)₂, magnesium di-hydroxide Mg(OH)₂ and magnesium oxide, and fitting the general formula a Ca(OH)₂.b Mg(OH)₂.c MgO. a, b and c represent mass fractions for which the sum has the value from 60 to 100%. The particles may further contain 0 to 40% by mass fraction of diverse compounds D, which may obviously contain impurities, i.e. phases derived from SiO₂, Al₂O₃, Fe₂O₃, MnO, P₂O₅ and/or SO₃, globally representing a few tens of grams per kilogram of lime. These solid particles may also contain as a material D calcium oxide which would not have been hydrated during the slaking, just like they may contain calcium carbonate CaCO₃ and/or magnesium carbonate MgCO₃, optionally combined as dolomite.

This calcium-magnesium hydrated lime is the industrial result of slaking of a quick dolomite with water, a reaction also called a hydration, or the result of mixing hydrated calcium lime and/or hydrated magnesia and/or dolomitic hydrated lime. The proportion of calcium and of magnesium is typically dictated by the proportion of the diverse added components and giving the possibility of leaving the native proportion existing in the different ores between 0.8 and 1.2.

By quick calcium lime, is meant a mineral solid material for which the chemical composition is mainly calcium oxide CaO. Quick lime is commonly obtained, by calcination of limestone, mainly consisting of CaCO₃. Quick lime contains impurities, i.e. compounds such as magnesium oxide, MgO, silica, SiO₂ or further alumina, Al₂O₃, etc. . . . , in an amount of a few percent. It is understood that these impurities are expressed in the aforementioned forms but may in reality appear in different phases. It also generally contains a few percent of residual CaCO₃, called non-baked residues.

By magnesia, in the sense of the present invention is meant a mineral solid material, for which the chemical composition is mainly magnesium oxide, MgO. Magnesia may be obtained by calcination of magnesium carbonate, mainly consisting of MgCO₃ or by oxidation of magnesium. Magnesium may therefore also contain impurities, i.e. compounds such as calcium oxide, CaO, silica, SIO₂ or further alumina Al₂O₃, etc. . . . , in an amount of a few percent it is understood that these impurities are expressed in the aforementioned forms but mainly appear in different phases in reality.

The calcium-magnesium or dolomitic quick lime is a mineral solid material, for which the chemical composition is mainly calcium oxide, CaO and magnesium oxide MgO. The calcium-magnesium or dolomitic quick lime is commonly obtained by calcination of dolomite, mainly consisting of CaCO₃ and of MgCO₃. Quick lime contains impurities, i.e., compounds such as silica, SiO₂, or further alumina Al₂O₃, etc. . . . , in an amount of a few percent. It is understood that these impurities are expressed in the aforementioned forms but may in reality appear in different phases. It also contains generally a few percent of residual CaCO₃ and MgCO₃, called non-baked residues. Depending on whether the quick lime further comprises an exogenous addition of MgO or CaO for varying the Ca/Mg proportion, it will be designated as calcium-magnesium lime while if it directly sterns from the calcination of dolomite, it will be called dolomitic quick lime.

In the sense of the present invention, quick lime with retarded reactivity wiii designate quick limes for which the reactivity to water measured by t₆₀ according to the EN 459-2 standard is extended. These limes typically comprise quick limes with exogenous additives, over-baked quick limes and partly pre-hydrated limes.

The lime with an exogenous additive is a lime in which the quick lime particles are treated at the surface, more particularly coated with a layer of an additive more or less sensitive to water which acts as a protective layer for retarding the contacting with the water from the core of quick lime.

The pre-hydrated lime is also a lime treated at the surface and more particularly a lime to which a small amount of water has been added, insufficiently for being able to slake the whole of the quick lime particles. Consequently, the most accessible portion to water, i.e. the external surface, will react with water in order to form slaked lime and quick lime particles (in their core) coated with at least partly a layer of slaked lime on the outer surface will be obtained.

The over-baked lime is a lime having been subject to a bulk treatment, i.e. a densified lime, or even sintered obtained by extended baking and/or at a higher temperature of the quick lime. The thereby obtained over-baked lime is more difficult to access with water since it is somewhat more packed or more crammed. Therefore the reaction with water is retarded.

In the case of filter dusts, flying ashes, in particular calcium ashes, Portland cements, these are compounds providing lime immediately or in a retarded way, the lime is formed accordingly from hydration of the cement.

Preferably, said lime composition is a solid composition or a suspension such as for example lime milk or lime slurry. The lime suspensions may be diluted or concentrated, depending on the desired water content and may also be stabilized by means of additives allowing stabilization of the dynamic viscosity of the lime milk.

Such slaked lime suspensions or milks/slurries or further lime cream are commonly obtained by slaking quick lime with an excess of water £either large or not) or by suspending powdery slaked lime. The obtained particles predominantly consist of calcium or magnesium hydroxide, depending on the type of quick or hydrated lime used.

The viscosity of a lime milk is a determining property as to the application and the handling (pumping, conveyance in a conduit, . . . ) of the suspension. For this purpose, experience gave the possibility of establishing that the dynamic viscosity of the suspension should be less than 2,000 mPa·s, preferably less than 1,500 mPa·s.

Indeed, as mentioned hereinbefore, the present invention provides different physical or conditioning states of lime for treating the aggregate. Therefore provision is made for treating a too humid aggregate with powdery quick lime in order to reduce the water content thereof and to obtain a lime milk in situ, or to provide the lime in the form of dry hydrated lime, on a slightly humid aggregate for which modification of the water content is not desired, or further for providing lime as lime milk. In this way, a tailored solution may be contemplated depending on the initial water content of the aggregate and of its desired final water content.

In a particular embodiment of the method, said coating step further comprises a step for bringing an aqueous phase in particular, when provision of water is appropriate or when the provision of lime for the coating is achieved by mixing powdery lime with the aggregate or a first fraction of the aggregate in a kneader.

Advantageously, said aggregate is selected from the group of gravels, sands and fillers, artificial aggregates, such as for example aggregates stemming from deconstruction, special aggregates (lightweight aggregates such as clays, shales or expanded slags, aggregates with a high characteristic industrially elaborated such as calcined bauxites . . . ), aggregates of by-products from other industries (slag, . . . ) and mixtures thereof.

More particularly, said aggregate belongs to a granular class d/D expressed according to the EN 13043 standard, in terms of lower d and greater D dimensions of a sieve from 0/4 to 0/30, in particular a granular class selected from the group consisting of the granular classes of 0/4, 0/6, 0/8, 0/10, 0/14, 0/20, 0/30 and mixtures thereof.

For the more specific case of WSDs, said aggregate belongs to a granular class d/D expressed according to the EN 13043 standard, in terms of lower d and greater D sieve dimensions from 2/4 to 10/14, in particular a granular class selected from the group consisting of the granular classes 2/4, 2/6, 4/6, ⁶/₁0, 10/14 and mixtures thereof.

In the case of a cold-process coating formula, different types of aggregates may be used. These aggregates may therefore be gravels of different sizes, sand and fillers or further a mixture of these aggregates, by using several aggregate calibers. The whole of the calibers or only a fraction of a aggregate may be treated with lime. In particular, in the case of cold bitumens, it is possible to prefer the treatment of the largest aggregates in order to promote anchoring of the emulsion at their surface, the emulsion otherwise having a preference for finer aggregates (sand and filler). It is also possible to promote the treatment of fine aggregates in order to enhance the anchoring of this fraction or further treating an intermediate class. Of course, the preferential treatment may relate to a granular fraction in particular or a combination of several fractions. Also, a ripening period from a few seconds to a few days may be contemplated, for example giving the possibility of ensuring complete hydration of a weakly reactive quick lime in the presence of the natural humidity of the aggregate.

By binder is meant any hydrocarbon binder of fossil or synthetic origin which may be used for producing roadway materials. The binder may therefore be a bitumen stemming from the refining of oil or a synthetic bitumen.

According to a particular embodiment of the method according to the present invention, said binder may comprise one or several polymers and/or one or several acids and/or one or several fluxing agents as an additional additive of the bitumen and/or of the bitumen emulsion.

In particular, said binder may comprise a conventional bitumen emulsion additive, like a cationic surfactant containing nitrogen-containing functional groups such as amines, imidazolines, amidoamines which especially are the main emulsifiers used for cationic bitumen emulsions. The latter are made active by decreasing the pH via an acid, generally hydrochloric acid.

Thus, the binder may comprise additives currently used in the roadway field, such as polymers (EVA or ethylene-vinyl acetate, SBS or styrene-butadiene-styrene, SB or styrene-butadiene) either cross-linked or not, small rubber powders, plant waxes or of petrochemical origin, adhesiveness dopants, acids in particular polyphosphoric acids, fluxing agents or regenerating agents of petroleum, coal, plant origin or further animal origin, as well as optional cross-linking agents for these fluxing agents.

Other embodiments of the method according to the invention are indicated in the appended claims.

The object of the invention is also a cold-process bituminous coating composition comprising a bituminous binder, initially as a cationic bitumen emulsion, and a aggregate.

The composition according to the present invention is characterized in that said aggregate comprises at least one first fraction of an aggregate coated with lime.

In particular, said lime is selected from the group consisting of calcium hydrated limes, dolomitic hydrated limes, hydrated magnesias, calcium-magnesium hydrated limes, quick calcium limes, magnesia, calcium-magnesium or dolomitic quick limes, quick limes with retarded reactivity, such as for example partly pre-hydrated limes, over-baked quick limes, partly slaked limes with exogenous additives and mixtures thereof, filter dusts, flying ashes, in particular calcium ashes, Portland cements, hydraulic limes, construction limes as defined in the EN 459-1 standard, and mixtures thereof.

Advantageously, said bituminous coating composition according to the present invention comprises a lime content from 0.05 to 2% by weight, expressed as a hydroxide equivalent (Ca(OH)₂ and/or Mg(OH)₂) based on the total weight of aggregate.

Advantageously, in the composition according to the present invention, said aggregate is selected from the group of gravels, sands and fillers of artificial aggregates, such as for example aggregates from deconstruction, special aggregates, aggregates of by-products from other industries and mixtures thereof.

Preferably, said aggregate belongs to a granular class dID expressed according to the EN 13043 standard, in terms of lower d and greater D sieve dimensions from 0/4 to 0/30, in particular a granular class selected from the group consisting of granular classes of 0/4, 0/6, 0/8, 0/10, 0/14, 0/20, 0/30 and mixtures thereof.

In an alternative of the composition according to present invention, particularly targeted WSDs, said aggregate belongs to a granular class dID expressed in terms of lower d and greater D sieve dimensions from 2/4 to 10/14, in particular a granular class selected from the group consisting of the granular classes 2/4, 2/6, 4/6, 6/10, 10/14 and mixtures thereof.

In a preferential embodiment, said binder may comprise one or several polymers and/or one or several acids and/or one or several fluxing agents as an additional additive for the bitumen or for the bitumen emulsion.

More particularly, in an embodiment, the composition according to the invention further comprises a conventional additive for a bitumen emulsion, such as a cationic surfactant containing nitrogen-containing functional groups such as amines, imidazolines, amidoamines which are especially the main emulsifiers used for cationic bitumen emulsions. The latter are made active by reducing the pH via an acid, generally hydrochloric acid.

Thus, the binder may comprise additives currently used in the roadway field, such as polymers (EVA or ethylene-vinyl acetate, SBS or styrene-butadiene-styrene, SB or styrene-butadiene) either cross-linked or not, small rubber powders, plant waxes or of petrochemical origin, adhesiveness dopants, acids in particular polyphosphoric acids, fluxing agents or regenerating agents of oil, coal, plant or further animal origin, as well as optional cross-linking agents for these fluxing agents.

In a particular embodiment according to the present invention, the cold-process bituminous coating composition is a cold bitumen in the form of a composition of cold dense bitumens, a composition of grave emulsions or an emulsion re-treatment composition.

In this alternative, the composition according to the invention advantageously has a retained resistance measured according to the NLT-162 standard greater than or equal to 50%, preferably greater than or equal to 60%, in particular greater than or equal to 75%.

In another alternative according to the present invention, the cold-process bituminous coating composition is in the form of a wear surface dressing (WSD) composition.

In this other alternative, the composition according to the invention advantageously has a cohesion measured after 30 mins of ripening at room temperature by a Vialit plate test according to the EN 12272-3 standard, characterized by a content of detached aggregates of less than 85/100 aggregates, preferably less than 75/100 aggregates and more advantageously less than 65/100 aggregates.

Other embodiments of the composition according to the invention are indicated in the appended claims.

The invention also relates to a use of lime for coating aggregates with a cold-process bituminous coating.

More particularly, the invention relates to a use of lime for coating aggregates with a cold-process bituminous coating wherein the cold-process bituminous coating is based on a cationic emulsion of bitumen and is selected from wear surface dressings (WSD), cold-process bitumen coatings, selected from the group consisting of cold dense bitumen coatings, grave emulsion coatings and emulsion re-treatment coatings.

Other forms of use of the composition according to the invention are indicated in the appended claims.

Other features, details and advantages of the invention will become apparent from the description given hereafter, as non-limiting and referring to the examples.

The object of the invention is therefore to provide a method giving the possibility of improving the adhesiveness of the bituminous binder to the aggregate, the cohesion and setting speed, in particular when they are young, of a cold-process bituminous coating using the bitumen emulsion technique.

The method for preparing cold-process bituminous coatings, in particular wear surface dressings (WSD) according to the invention therefore comprises a step for preparing a bituminous binder as a cationic emulsion of bitumen which may comprise one or several polymers and/or one or several acids and/or one or several fluxing agents as an additional additive of bitumen and/or of bitumen emulsion.

A aggregate is also prepared, typically from gravels and/or sands and/or fillers and/or artificial aggregates, such as for example aggregates from deconstruction, special aggregates, aggregates of by-products from other industries and mixtures thereof.

These different types of aggregates have different calibers. According to the applications, the aggregate will have a single fraction of a caliber or a mixture of fractions of different calibers or of a same caliber. At least one fraction of aggregate is treated with lime in an amount of a lime content from 0.05 to 2% expressed in hydroxide equivalent (Ca(OH)₂ and/or Mg(OH)₂) based on the total weight of aggregate in order to form an aggregate or an aggregate fraction coated with lime. The whole of the calibers or an aggregate fraction alone may be treated. In particular, in the case of cold bitumens, preference may be given to the treatment of greater aggregates in order to promote anchoring of the emulsion at their surface, the emulsion otherwise having a preference for finer aggregates (sand and filler). It is also possible to promote the treatment of finer aggregates in order to enhance the anchoring on this fraction or else for treating an intermediate class. Of course, the preferential treatment may relate to one granular fraction in particular or to a combination of several fractions. Also, a ripening period from a few seconds to a few days may be contemplated, for example giving the possibility of ensuring complete hydration of a weakly reactive quick lime in the presence of the natural humidity of the aggregate.

The method according to the invention therefore consists of treating a aggregate with lime before using it in a formulation of a cold-process coating based on a bitumen emulsion.

It may be produced by any suitable means allowing good control of the lime content, and may be adapted according to the powdery nature or liquid nature of the lime use. In a non-restrictive way, the aggregate may be mixed with lime in a kneader, for example similar to those found in concrete plants. The lime may also be directly sprayed at the surface of the aggregate by a spraying system on a conveyer belt or at the output of a chip spreader then using devices similar to the dopant ramps already marketed. The treatment may be carried out just before putting the aggregate in contact with the emulsion or further upstream in the quarry, with a storage which may range up to a few days. A longer storage is not recommended since it would induce a carbonation of the lime which was then transformed into calcium carbonate and would then loose its activity.

The thereby prepared aggregate and the bituminous binder are thus placed on a surface to be coated. The aggregate may be directly brought onto the surface to be coated in one or several layers, or further on the bituminous binder layer positioned beforehand. Everything depends on the targeted application, on the thickness of the layers, being aware that they may also be positioned on each other alternately.

The cold-process bituminous coating is thus formed with at least one layer of said aggregate interpenetrated in said binder layer.

The binder and the aggregate may also be prepared as a mixture in a coating plants, such as for example a mobile plant and be directly applied as a mixture on the roadway.

The lime is selected from the group consisting of calcium hydrated limes, dolomitic hydrated limes, hydrated magnesias, calcium-magnesium hydrated limes, quick calcium limes, magnesia, calcium-magnesium or dolomitic quick limes, quick limes with retarded reactivity, such as for example partly pre-hydrated limes, over-baked quick limes, partly slaked limes with exogenous additives and mixtures thereof, filter dusts, flying ashes, in particular calcium ashes, Portland cements, hydraulic limes, construction limes as defined in the EN 459-1 standard, and mixtures thereof and the composition may be in solid, powdery form or in the form of a suspension.

The lime suspensions may be diluted or concentrated, depending on the desired water content and may also be stabilized by means of additives giving the possibility of stabilizing the dynamic viscosity of the lime milk.

If required, an aqueous may further be added depending on the initial humidity contained in the aggregate and on its desired final humidity.

### EXAMPLES

For the examples below, a bitumen emulsion called EMB1 with rapid breakage for forming a cold-process bituminous coating in the following way:

A bitumen emulsion EMB1 was manufactured by mixing the following ingredients in a laboratory plot equipped with a colloidal mill:

66 parts by mass of bitumen 1601220 at a temperature of 140° C., stemming from the Repsol refinery of Puertoliana (Spain).

34 parts of an aqueous phase at a temperature of 40° C., consisting of water, of 0.16 portions of tallow diamine (Asfier 100 provided by Kao) and of a supplement of hydrochloric acid giving the possibility of adjusting the pH to a value of 2.2.

An emulsion with 66% of binder EMB1 having a breakage index of 88 according to the EN 13075-1 standard is thereby obtained which corresponds to an emulsion of the type C6584 according to the EN 13808 standard. This type of emulsion is currently used for WSDs and is known as an “emulsion with rapid breakage” in the business.

### Comparative Example 1

### Manufacturing of a WSD (EC1)

A WSD (EC1) was made in the laboratory or within the scope of a Vialit plate test according to the EN 12272-3 standard. This is completely accomplished by applying the emulsion EMB1 in an amount of 1 kg/m² of residual binder on a normalized metal plate of 20×20 cm². 100 silica-calcium aggregates G1 of caliber 6/10 stemming from the gravel pit of Jarama (Madrid, Spain) are regularly positioned at the surface of the freshly spread emulsion. After a ripening time of 30 minutes at room temperature, the WSD is subject to the test: The plate is turned over (aggregates oriented on the ground side) and a normalized steel ball of 510 g is released on the plate 3 times in succession from a height of 50 cm. At the end of the impacts, the aggregates which have detached from the plates are counted by separating clean aggregates and stained aggregates (i.e. the aggregates on which the binder adheres). The number of aggregates remaining stuck is thus evaluated as well as those fallen but clean or stained. The aggregates which remain stuck correspond both to good adhesiveness and good cohesion. The aggregates fallen and clean correspond to poor adhesiveness. The aggregates fallen, stained correspond to poor cohesion but to good adhesiveness. The given results are obtained as an average of 3 repetitions.

The results on WSD (EC1) as a reference are resumed in Table 1. Thus, after 30 minutes, it appears that quasi all the aggregates (96) have been detached from the plate following the impact and they all stained. This therefore indicates insufficient cohesion of the WSD after 30 minutes,

### Example 1

### Manufacturing of WSD Coatings (E1) According to the Invention.

The WSD (E1) according to the invention was made in the laboratory. To do this, the same test (Vialit) as for WSD (EC1) as a reference was used. The same emulsion EMB1 was applied in an amount of 1 kgirn² of residual binder. The same aggregate G1 from the gravel pit of Jararna was also used, but it was treated beforehand this time with 0.25% by mass of concentrated lime milk stabilized at 45% by mass of hydrated lime (provided by Lhoist). This represents a supply of 0.11% of hydrated lime relatively to the aggregate. The aggregates were then positioned regularly at the surface of the freshly spread emulsion like for the WSD (EC1), thereby forming WSD (E1). After 30 minutes of ripening, the WSD is subject to the test.

The results on WSD (E1) according to the invention are again taken up in Table 1. It appears that a larger amount of aggregates (15) now remains stuck to the plate in spite of the impacts. This therefore indicates a clearly improved cohesion as compared with WSD (EC1) after 30 minutes, by means of the prior treatment of the aggregate with lime.

### Example 2

### Manufacturing of WSD Coatings (E2) According to the Invention.

The WSD (E2) according to the invention was made in the laboratory. To do this, the same test (Vialit) as for the WSD (EC1) as a reference was used. The same EMB1 emulsion was applied in an amount of 1 kg/n² of residual binder. The same aggregate G1 stemming from the Jarama gravel pit was also used, but it was treated beforehand this time with 0.5% by mass of concentrated lime milk stabilized to 45% by mass of hydrated lime (provided by Lhoist).

This represents a supply of 0.23% of hydrated lime relatively to the aggregate. The aggregates were then positioned regularly at the surface of the freshly spread emulsion like for WSD (EC1), thereby forming WSD (E2). After 30 minutes of ripening, the WSD is subject to the test.

The results on WSD (E2) according to the invention are taken up again in Table 1. It appears that a larger amount of aggregates (21) now remain stuck to the plate in spite of the impacts. This therefore indicates a clearly improved cohesion relatively to WSD (EC1) after 30 minutes, by means of the preliminary treatment of the aggregate with iime.

### Example 3

### Manufacturing of WSD (E3) According to the Invention.

The WSD (E3) according to the invention was made in the laboratory. In order to do this, the same test (Vialit) as for WSD (EC1) as a reference was used. The same EMB1 emulsion was applied in an amount of 1 kg/m² of residual binder. The same aggregate (31 stemming from the Jarama gravel pit was also used, but this time it was treated with 1% by mass of concentrated lime milk stabilized to 45% by mass of hydrated lime (provided by Lhoist). This represents a supply of 0.45% of hydrated lime relatively to the aggregate. The aggregates were then positioned regularly at the surface of the freshly spread emulsion like for WSD (EC1), thereby forming WSD (E3). After 30 minutes of ripening, the WSD is subject to the test.

The results on WSD (E3) according to the invention are again taken up in Table 1. It appears that a larger amount of aggregates (14) now remain stuck to the plate in spite of the impacts. This therefore indicates clearly improved cohesion relatively to the WSD (EC1) after 30 minutes, by means of the prior treatment of the aggregate with lime.

### Comparative example 2

### Manufacturing of the WSD Coating (EC2).

A WSD (EC2) was made in the laboratory according to the prior art. To do this, the same test (Vialit) as for the reference WSD (EC1) was used. This is accomplished by applying the same EMB1 in an amount of 1 kg/m² of residual binder. Next, the spread emulsion was treated with 3% of a diluted lime milk, obtained by mixing 1 volume of industrial stabilized lime milk with 10 volumes of water. It should be noted that the amount of total hydrated lime represents about one quarter of the one used for the WSD (E2). A larger amount causes a breakage at the surface of the emulsion (skin), which does not give the possibility of properly embedding the aggregates. The aggregates G1 were then positioned regularly at the surface of the freshly spread emulsion. After 30 minutes of ripening, the WSD is subject to the test.

The results on the WSD (EC2) are again taken up in Table 1. It appears that after 30 minutes all the aggregates are detached. 7 detached aggregates are found to be clean, showing that the contact with the emulsion was perturbed by the direct supply of lime and the formation of a skin surface of the WSD, which prevents good contact with the aggregate. Also, it appears that the surface aspect is very poor, with certain aggregates mixed in the bitumen skin and a non-broken residual emulsion portion. Even if they had been able to remain stuck to the plate under the conditions of the test, it is clear that the passage of traffic would have generated immediate run of the WSD. Also, the presence of clean detached aggregates shows that the risk of detachment and therefore of windshield breakages, is very significant with this formula. Also, the results are clearly inferior to those obtained for the reference WSD (EC1).

TABLE 1

| | WSD | WSD | WSD | WSD | WSD |
|---|---|---|---|---|---|
| WSD—examples | (EC1) | (E1) | (E2) | (E3) | (EC2) |
| Emulsion | EMB1 | EMB1 | EMB1 | EMB1 | EMB1 |
| Aggregate | G1 | G1 | G1 | G1 | G1 |
| Treatment (in % of hydrated | 0 | 0.11% | 0.23% | 0.45% | 0.12% |
| lime relatively to the | | | | | |
| aggregate) | | | | | |
| Adherent aggregates (after | 4 | 15 | 21 | 14 | 0 |
| 30 minutes) | | | | | |
| Clean detached aggregates | 0 | 0 | 0 | 0 | 7 |
| (after 30 minutes) | | | | | |
| Stained detached | 96 | 85 | 79 | 86 | 93 |
| aggregates (after 30 | | | | | |
| minutes) | | | | | |

### Comparative example 3

### Manufacturing of a Reference WSD (EC3).

A WSD (EC3) was made in the laboratory within the scope of a test with the Viailt plate by applying the EMB1 in an amount of 1 kg/m² of residual binder on a normalized metal plate of 20×20 cm². 100 mylonitic aggregates G2 of calibre 6/10 stemming from the Almonacid gravel pit in Toledo (Castilla La Mancha, Spain) are regularly positioned at the surface of the freshly spread emulsion. After a ripening time of 30 mins at room temperature, the WSD is subject to the test in the same way as described earlier.

The results on the reference WSD (EC3) are again taken up in Table 2. Thus, after 30 mins, it appears that all the aggregates (100) have been detached from the plate subsequently to the impact and that they are all stained. This therefore indicates insufficient cohesion of the WSD after 30 rains.

### Examples 4 to 6

### Manufacturing of WSD Coatings (E4, E5, E6)

WSD coatings (E4, E5, E6) were made in the laboratory according to the invention. To do this, the same test (Vialit) as for the reference WSD (EC3) was used. This was done by applying the same EMB1 emulsion in an amount of 1 kgim² of residual binder. The same aggregate 32 was also used, but it was treated beforehand with 0.25, 0.5 or 1% by mass of industrial concentrated lime milk stabilized to 45% by mass of hydrated lime, provided by Lhoist. This respectively represents a supply of 0.11%, 0.23% and 0.45% of hydrated lime relatively to the aggregate. The aggregates were then regularly positioned at the surface of the freshly spread emulsion like for WSD (EC3), thereby forming the WSDs (E4, E5, E6) respectively. After 30 mins of ripening, the WSD is subject to the test.

The results on the WSDs (E4, E5, E6) according to the invention are again taken up in Table 2. It appears that a larger amount of aggregates (2, 11 and 7 respectively) remains now stuck to the plate in spite of the impacts. This therefore indicates a clearly improved cohesion relatively to the WSD (EC3) after 30 mins, by means of the prior treatment of the aggregate with lime.

TABLE 2

| | WSD | WSD | WSD | WSD |
|---|---|---|---|---|
| WSD—examples | (EC3) | (E4) | (E5) | (E6) |
| Emulsion | EMB1 | EMB1 | EMB1 | EMB1 |
| Aggregate | G1 | G1 | G1 | G1 |
| Treatment (in % of | 0 | 0.11% | 0.23% | 0.45% |
| hydrated lime relatively | | | | |
| to the aggregate) | | | | |
| Adherent aggregates | 0 | 2 | 11 | 7 |
| (after 30 minutes) | | | | |
| Clean detached | 0 | 0 | 0 | 0 |
| aggregates (after 30 | | | | |
| minutes) | | | | |
| Stained detached | 100 | 98 | 89 | 93 |
| aggregates (after 30 | | | | |
| minutes) | | | | |

### Example 7

### Manufacturing of a Bitumen Emulsion EMB2 with Rapid Breakage.

A bitumen emulsion EMB2 was manufactured by mixing the following ingredients in a laboratory pilot installation equipped with a colloidal mill:

66 parts by mass of bitumen 160/220 at a temperature of 140° C., stemming from the Repsol refinery of Puertollano (Spain).

34 parts of an aqueous phase at a temperature of 40° C., consisting of water, of 0.2 portions of tallol fatty amides (indulin R66 provided by MeadWestVaco) and a supplement of hydrochloric acid giving the possibility of adjusting the pH to a value of 2.5.

An emulsion with 66% of binder EMB2 is thereby obtained with a breakage index of 90 according to the EN 13075-1 standard which corresponds to an emulsion of the C65B4 type according to the EN 13808 standard. This type of emulsion is currently used for WSDs and is known as an “emulsion with rapid breakage” in the profession.

### Comparative Example 4

### Manufacturing of a Reference WSD (EC4)

A WSD (EC4) was made in the laboratory within the scope of a Vialit plate test by applying the EMB2 emulsion of Example 7 in an amount of 1 kg/m² of residual binder on a normalized metal plate of 20×20 cm². 100 aggregates G1 stemming from the Jarama gravel pit are regularly positioned at the surface of the freshly spread emulsion. After a ripening time of 30 mins at room temperature, the WSD is subject to the test in the same way as described earlier.

The results on the reference WSD (EC4) are again taken up in Table 3. Thus, after 30 mins, it appears that many aggregates (85) are detached from the plate subsequently to the impact and they are all stained. This therefore indicates low cohesion of the WSD after 30 mins.

### Example 8 to 10

### Manufacturing of the WSD coatings (E8, E9, E10).

WSD coatings (E8, E9, E10) were made in the laboratory according to the invention. For this, the same test (Vialit) as for the reference WSD (EC4) was used. This was done by applying the same emulsion EMB2 according to Example 7 in an amount of I kg/m² of residual binder. The same aggregate G1 was also used, but it had been treated beforehand with 0.25. 0.5 or 1% by mass of industrial concentrated lime milk stabilized at 45% by mass of hydrated lime, provided by Lhoist. This respectively represents a supply of 0.11%, 0.23% and 0.45% of hydrated lime relatively to the aggregate. The aggregates were then positioned regularly at the surface of the freshly spread emulsion like for the WSD (EC4) thus making up the WSDs (E8, E9, E10) respectively. After 30 mins of ripening, the WSD is subject to the test.

The results on the WSDs (E8, E9, E20) according to the invention are again taken up in Table 3. It appears that a larger amount of aggregates (32, 46 and 43 respectively) now remains stuck to the plate in spite of the impacts.

This therefore indicates that a clearly improved cohesion relatively to the WSD (EC4) after 30 mins, by means of the prior treatment of the aggregate with lime.

TABLE 3

| | WSD | WSD | WSD | WSD |
|---|---|---|---|---|
| WSD—examples | (EC4) | (E8) | (E9) | (E10) |
| Emulsion | EMB2 | EMB2 | EMB2 | EMB2 |
| Aggregate | G1 | G1 | G1 | G1 |
| Treatment (in % of hydrated | 0 | 0.11% | 0.23% | 0.45% |
| lime relatively to the | | | | |
| aggregate) | | | | |
| Adherent aggregates (after | 15 | 32 | 46 | 43 |
| 30 minutes) | | | | |
| Clean detached aggregates | 0 | 0 | 0 | 0 |
| (after 30 minutes) | | | | |
| Stained detached | 85 | 68 | 54 | 57 |
| aggregates (after 30 | | | | |
| minutes) | | | | |

### Comparative Example 5

### Manufacturing of a Reference WSD (EC5)

A WSD (EC5) was made in the laboratory within the scope of a Vialit plate test by applying the EMB2 emulsion according to Example 7 in an amount of 1 kg/m² of residual binder on a normalized metal plate of 20×20 cm². 100 mylonitic aggregates G2 of caliber 0/10 stemming from the Almonacid gravel pit in Toledo (Castilla La Mancha, Spain) are regularly positioned at the surface of the freshly spread emulsion. After a ripening time of 30 mins at room temperature, the WSD is subject to the test in the same way as described earlier.

The results on the WSD (ECS) are again taken up in Table 4. Thus, after 30 mins, it appears that nearly all the aggregates (99) are detached from the plate subsequent to the impact and that they are all stained. This therefore indicates insufficient cohesion of the WSD after 30 mins.

### Example 11 to 13

### Manufacturing of the WSD coatings (E11, E12, E13).

WSD coatings (E11 , E12, E13) were made in the laboratory according to the invention. To do this, the same test (Vialit) as for the reference WSD (ECS) was used. This is accomplished by applying the same EMB2 emulsion according to Example 7 in an amount of 1 kg/m² of residual binder. The same aggregate SG2 was also used, but it had been treated beforehand with 0.25, 0.5 or 1% by mass of an industrial concentrated lime milk stabilized to 45% by mass of hydrated lime, provided by Lhoist. This respectively represents a supply of 0.11%, 0.23% and 0.45% of hydrated lime relatively to the aggregate. The aggregates were then positioned regularly at the surface of the freshly spread emulsion like for the WSD (EC5) thereby making up the WSDs (E11, E12, E13) respectively. After 30 mires of ripening, the WSD is subject to the test.

The results on the WSDs (E11, E12, E13) according to the invention are again taken up in Table 5. It appears that a larger amount of aggregates (23, 36 and 26 respectively) now remains stuck to the plate in spite of the impacts. This therefore indicates a clearly improved cohesion relatively to the WSD (EC5) after 30 mins, by means of the prior treatment of the aggregate with lime.

TABLE 4

| | WSD | WSD | WSD | WSD |
|---|---|---|---|---|
| WSD—examples | (EC5) | (E11) | (E12) | (E13) |
| Emulsion | EMB2 | EMB2 | EMB2 | EMB2 |
| Aggregate | G2 | G2 | G2 | G2 |
| Treatment (in % of hydrated | 0 | 0.11% | 0.23% | 0.45% |
| lime relatively to the | | | | |
| aggregate) | | | | |
| Adherent aggregates (after | 1 | 23 | 36 | 26 |
| 30 minutes) | | | | |
| Clean detached aggregates | 0 | 0 | 0 | 0 |
| (after 30 minutes) | | | | |
| Stained detached | 99 | 77 | 64 | 74 |
| aggregates (after 30 | | | | |
| minutes) | | | | |

### Examples 14 and 15

### Manufacturing of WSD Coatings (E14, 15).

WSDs (E14, E15) were manufactured as earlier, by using the WSD formulae (E5 and E12) respectively, but this time by letting the aggregate treated with lime mlik for 24 hours before its use in the WSD. The results are given in the following Table 5, wherein it appears that the beneficial effect of the treatment is obvious relatively to the VsiSD references (EC3) and (EC5) respectively (Tables 2 and 4).

TABLE 5

| | WSD | WSD |
|---|---|---|
| WSD —examples | (E11) | (E12) |
| Emulsion | EMB2 | EMB2 |
| Aggregate | G2 | G2 |
| Treatment (in % of hydrated | 0.93% | 0.23% |
| lime relatively to the | | |
| aggregate) | | |
| Adherent aggregates (after | 12 | 29 |
| 30 minutes) | | |
| Clean detached aggregates | 0 | 0 |
| (after 30 minutes) | | |
| Stained detached | 88 | 71 |
| aggregates (after 30 | | |
| minutes) | | |

### Example 16

### Manufacturing of a Bitumen Emulsion EMB3 with Slow Breakage.

A bitumen emulsion EMB3 was manufactured by mixing the following ingredients in a laboratory pilot installation equipped with a colloidal mill:

60 parts by mass of bitumen 70/100 at a temperature of 140° C., stemming from the Repsol refinery of Puertollano (Spain),

40 parts of an aqueous phase at a temperature of 40° C., consisting of 0.6 parts (based on the emulsion) of ethoxylated diamine channel (Asfier 218 provided by Kao) and a supplement of hydrochloric acid allowing adjustment of the pH to a value of 2.5.

An emulsion with 60% of EMB3 binder is thereby obtained with a breakage index of 260 according to the EN 13075-1 standard which corresponds to an emulsion of the C80B6 type according to the EN 13808 standard. This type of emulsion is currently used for cold bitumens and is known as an “emulsion with slow breakage” in the profession,

### Comparative Example 6

### Manufacturing of a Reference Grave-Emulsion GE1 (EC6).

A GE 1 (EC6) was made in laboratory. To do this, a aggregate G3 of grain size 0/25 from the Jarama gravel pit was used. This aggregate, with its natural humidity of 2%, was coated with 6% of the EMB3 emulsion according to Example 16 in order to finally obtain a bitumen content of 3.6%, and a supplement of 3.5% of water. The thereby obtained material was then compacted into cylindrical molds according to the Spanish NLT-161 standard. The specimens of GE 1 (ECG) thereby obtained were weighed for determining the density thereof and next conditioned according to the Spanish standard NLT-162 in order to measure the dry resistance and the resistance after an immersion of 24 hours in a bath at 60° C. The ratio of the resistances after immersion and under dry conditions, called the retain resistance, is then calculated. Depending on the targeted traffic, a value greater than 50, 60 or 75% is required in Spain for GEs. The GE 1 (EC6) obtains a value of 63% making it acceptable for a maximum traffic of 200 trucks/day (truck/j).

### Example 17 and 18

### Manufacturing of a Grave-Emulsion GE 2 (E17) AND GE 3 (E18)

GE 2 (E17) and GE 3 (E18) were manufactured according to the invention by using a recipe similar to that of GE 1 (EC6), with however a preliminary treatment of the aggregate G3 with 0.5 or 1% by mass of industrial concentrated lime milk stabilized at 45% by mass of hydrated lime, provided by Lhoist. This respectively represents a supply of 0.23% and 0.45% of hydrated lime relatively to the aggregate. The GE 2 and 3 were prepared according to the same steps of kneading and then compacting, and subject to the water resistance test (NLT-162). The results on the GE 2 and 3 according to the invention are taken up again in Table 6, It appears that the dry resistance and the retained resistance increase in a highly significant way by means of the treatment according to the invention, to the point that the specimens of GE 3 (E18) after immersion, however generating a damage, have a resistance greater than that under dry conditions of the reference GE 1 (ECG)l Also, GE 2 (E17) and GE 3 (E18) pass the most severe specification of retained resistance (75%). Unlike reference GE1 (EC6), they would thus be acceptable for a traffic of 800 trucks/d.

TABLE 6

| | GE | GE | GE |
|---|---|---|---|
| GE—examples | (EC6) | (E17) | (E18) |
| Emulsion | EMB3 | EMB3 | EMB3 |
| Aggregate | G3 | G3 | G3 |
| Treatment (in % of hydrated lime relatively to | 0 | 0.23% | 0.45% |
| the aggregate) | | | |
| Density (g/cm³) water resistance test (NLT-162) | 2.393 | 2.386 | 2.388 |
| Dry resistance (Mpa) | 1.77 | 2.11 | 2.23 |
| Resistance after immersion (MPa) | 1.11 | 1.62 | 1.91 |
| Retained resistance (%) | 63 | 77 | 86 |

### Example 19

### Manufacturing of WSD Coatings (E19) According to the Invention.

The WSD (E19) according to the invention was made in the laboratory. In order to do this, the same test (Vialit) as for the reference WSD (EC1) was used. The same emulsion EMB1 was applied in an amount of 1 kg/rn² of residual binder. The same aggregate G1 stemming from the Jarama gravel pit was also usedbut it had been treated beforehand this time with 0.2% by mass of quick lime (provided by Lhoist), in other words with 0.26% of lime expressed as a hydroxide equivalent. It should be noted that the aggregate had a water content of the order of 0.1° ,/o before treatment, and that the hydration reaction is therefore only partial before being put in contact with the emulsion, which will provide the supplement of water for completing the hydration. The aggregates were then positioned regularly at the surface of the freshly spread emulsion like for the WSD (EC1), thereby forming the WSD (E19). After 30 minutes of ripening, the WSD is subject to the test.

The results on the WSD (E19) according to the invention are taken up again in Table 7. It appears that a larger amount of aggregates (20) now remains stuck to the plate in spite of the impacts. This therefore indicates a clearly improved cohesion as compared with WSD (EC1) after 30 minutes, by the treatment beforehand of the aggregate with lime.

TABLE 7

| | WSD |
|---|---|
| WSD—examples | (E19) |
| Emulsion | EMB1 |
| Aggregate | G1 |
| Treatment (in % of hydrated lime relatively to the | 0.26% |
| aggregate) | |
| Adherent aggregates (after 30 minutes) | 20 |
| Clean detached aggregates (after 30 minutes) | 0 |
| Stained setached aggregates (after 30 minutes) | 80 |

### Comparative Example 7

### Manufacturing of WSD Coatings (EC7)

A WSD (EC7) was produced in the laboratory. To do this, the same test (Vialit) as for the reference WSD (EC1) was used. The same emulsion EMB1 was applied in an amount of 1 kg/m² of residual binder. The same aggregate GI from the Jarama gravel pit was also used, but it was treated beforehand this time with 6% by mass of lime milk (provided by Lhoist), in other words with 2.7% of lime expressed as a hydroxide equivalent. The aggregates were then positioned regularly at the surface of the freshly spread emulsion like for the WSD (EC1), thereby forming the WSD (EC7). The WSD manufactured in this way generates a heterogeneous breakage of the emulsion with formation of the skin under the aggregates and confinement of water, which does not give the possibility of measuring the cohesion thereof after 30 mins. This formula is therefore not applicable on a roadway.

It is well understood that the present invention is by no means limited to the embodiments described above and that many modifications may be made thereto without departing from the scope of the appended claims.

1. A method for preparing cold-process bituminous coatings, in particular of wear surface dressings (WSD), comprising the steps of:
(a) preparing a bituminous binder as a cationic emulsion of bitumen,
(b) preparing an aggregate comprising at least one first aggregate fraction, and
(c) forming said cold-process bituminous coating formed with at least said aggregate interpenetrated into said binder;
characterized in that said step for preparing said aggregate comprises a step for coating said at least one first aggregate fraction with lime.

2. The preparation method according to claim 1, comprising:
(i) at least one bringing of said bituminous binder onto a surface to be coated, in order to form a binder layer on said surface to be coated,
(ii) at least one bringing of said aggregate onto said surface to be coated, before or after said bituminous binder, and wherein said bituminous coating is formed with at least one layer of said aggregate interpenetrated in said bituminous binder.

3. The preparation method according to claim 2, wherein said bituminous coating is formed with at least one layer of said interpenetrated aggregate said aggregate interpenetrated in said bituminous binder comprises asymmetrical or symmetrical number of layers of bituminous binder and of aggregates possibly alternately.

4. The preparation method according to claim 1, wherein:
(i) said bituminous binder is brought into a kneader,
(ii) said aggregate is brought into said kneader, during, before or after said bituminous binder, and
(iii) said bituminous coating is formed with the mixture of said aggregate interpenetrated into said binder and is applied on a surface to be coated.

5. The preparation method according to claim 1, wherein said step for coating said at least one first aggregate fraction comprises application of a lime composition on said at least one first aggregate fraction by immersion, soaking, vaporization, spraying or mixing in an amount of a lime content from 0.05 to 2% by weight expressed in hydroxide equivalent (Ca(OH)₂ and/or Mg(OH)₂) based on the total weight of aggregate.

6. The preparation method according to claim 1, wherein said lime is selected from the group consisting of calcium hydrated limes, dolomitic hydrated limes, hydrated magnesias, calcium-magnesium hydrated limes, quick calcium limes, magnesia, calcium-magnesium or dolomitic quick limes, quick limes with retarded reactivity, including partly pre-hydrated limes, over-baked quick limes, partly slaked limes with exogenous additives and mixtures thereof, filter dusts, flying ashes, including calcium ashes, Portland cements, hydraulic limes, construction limes as defined in the EN 459-1 standard, and mixtures thereof.

7. The preparation method according to claim 5, wherein said lime composition is a solid composition or a suspension such as a lime milk or a lime slurry.

8. The preparation method according to claim 1, wherein said coating step further comprises a step for bringing an aqueous phase.

9. The method according to claim 1, wherein said aggregate is selected from the group consisting of gravels, sands and fillers, artificial aggregates, including aggregates stemming from deconstruction, special aggregates, aggregates of by-products from other industries and mixtures thereof.

10. The method according to claim 1, wherein said aggregate belongs to a granular class d/D expressed according to the EN 13043 standard, in terms of lower d and greater D sieve dimensions (in mm) from 0/4 to 0/30, in particular a granular class selected from the group consisting of the granular classes of 0/4, 0/6, 0/8, 0/10, 0/14, 0/20, 0/30 and mixtures thereof.

11. The method according to claim 1, wherein said aggregate belongs to a granular class d/D expressed in terms of lower d and greater D sieve dimensions from 2/4 to 10/14, in particular a granular classes selected from the group consisting of the granular classes 2/4, 2/6, 4/6, 6/10, 10/14 and mixtures thereof.

12. The method according to claim 1, wherein said bituminous binder may comprise one or several polymers, and/or one or several acids, and/or one or several fluxing agents as an additional additive of bitumen and/or of bitumen emulsion.

13. A cold-process bituminous coating composition comprising a bituminous binder initially as a cationic emulsion of bitumen and an aggregate, characterized in that said aggregate is an aggregate coated with lime.

14. The cold-process bituminous coating composition according to claim 13, wherein said lime is selected from the group consisting of calcium hydrated limes, dolomitic hydrated limes, hydrated magnesias, calcium-magnesium hydrated limes, quick calcium. limes, magnesia, calcium-magnesium or dolomitic quick limes, quick limes with retarded reactivity, including partly pre-hydrated limes, over-baked quick limes, partly slaked limes with exogenous additives and mixtures thereof, filter dusts, flying ashes including calcium ashes, Portland cements, hydraulic limes, construction limes as defined in the EN 459-1 standard, and mixtures thereof.

15. The cold-process bituminous coating composition according to claim 1, comprising a lime content from 0.05 to 2% by weight expressed as a hydroxide equivalent (Ca(OH)₂ and/or Mg(OH)₂) based on the total weight of aggregate.

16. The cold-process bituminous coating composition according to claim 13, wherein said aggregate is selected from the group consisting of gravels, sands and fillers, artificial aggregates including aggregates from deconstruction, special aggregates, aggregates of by-products from other industries and mixtures thereof.

17. The cold-process bituminous coating composition according to claim 13, wherein said aggregate belongs to a granular class d/D expressed in terms lower d and greater D sieve dimensions from 0/4 to 0/30, in particular a granular class selected from the group consisting of the granular classes of 0/4, 0/6, 0/8, 0/10, 0/14, 0/20, 0/30 and mixtures thereof.

18. The cold-process bituminous coating composition according to claim 13, wherein said aggregate belongs to a granular class d/D expressed in terms of lower d and greater D sieve dimensions from 2/4 to 10/14, in particular a granular class selected from the group consisting of the granular classes 2/4, 2/6, 4/6, 6/10, 10/14 and mixtures thereof.

19. The cold-process bituminous coating composition according to claim 13, wherein said binder may comprise one or several polymers, and/or one or several acids, and/or one or several fluxing agents as an additional additive of the bitumen and/or the bitumen emulsion.

20. The cold-process bituminous coating composition according to claim 13, further comprising a conventional additive to a bitumen emulsion, including a cationic surfactant containing nitrogen-containing functional groups, said functional groups being selected from the consisting of amines, imidazolines, amidoamines.

21. The cold-process bituminous coating composition according to claim 13, having a cohesion measured after 30 mins of ripening at room temperature by a Vialit plate test according to the EN 12272-3 standard characterized by a content of detached aggregates of less than 85/100 aggregates.

22. (canceled)

23. The cold-process bituminous coating composition according to claim 13, having a retained resistance measured according to the NIT-162 standard greater than or equal to 50%.

24. The cold-process bituminous coating composition according to claim 13, in the form of a cold-process bitumen composition, selected from the group consisting of a composition of cold dense bitumens, a composition of grave-emulsions or a composition of emulsion re-treatment.

25-26. (canceled)
